(19) United States
(12) Patent Application Publication
(10) Pub. No.: US 2008/0198874 A1
(43) Pub. Date: Aug. 21, 2008

(54) INTERWORKING DEVICE

(76) Inventor: KENSUKE MATSUSHIMA, Tokyo (JP)

Correspondence Address: Jackson Chen;NEC Corporation of America, 6535 N. State Hwy. 161, Irving, TX, 75039, US

(21) Appl. No.: 12/032,458

(22) Filed: Feb. 15, 2008

(30) Foreign Application Priority Data
Feb. 19, 2007 (JP) 2007-037884

(51) Int. Cl. H04L 29/06

(52) U.S. Cl. 370/466

(57) ABSTRACT

An interworking device includes an IuCS interface unit for an IuUP protocol signal, an Mb interface unit for an RFC3267 protocol signal, and protocol conversion means for performing protocol conversion between the IuUP protocol signal and the RFC3267 protocol signal. The protocol conversion means is connected to the IuCS interface unit and the Mb interface unit.

This application is based upon and claims the benefit of priority from Japanese patent application No. 2007-037884, filed on Feb. 19, 2007, the disclosure of which is incorporated herein in its entirety by reference.

### BACKGROUND OF THE INVENTION

1. Field of the Invention

The present invention relates to an interworking device, and in particular, to an interworking device which performs protocol conversion in a third generation (3G) mobile communication network.

2. Description of the Related Arts

An international standard regarding a third generation mobile network is compiled as a series of technical specifications of 3GPP (Third Generation Partnership Project) As specified in 3GPP TS23.002 and 3GPP TS25.415, a third generation mobile network is constructed of a CS (circuit switched) domain which uses a conventional circuit-switched network, and a PS (packet switched) domain which uses a packet-switched network. Hence, a mobile terminal or cellular phone which is used in the third generation mobile network is generally constructed so as to be able to respond to both the circuit-switched network and packet network. Examples of terminal devices which can respond to both the circuit-switched network and packet network are disclosed in, for example, WO02/09448, WO03/84096 and WO2004/073279, which are international publication of PCT applications.

By the way, an IMS (IP Multimedia Subsystem) is a system providing multimedia service in an IP (Internet Protocol) base without depending on an access network, for a third generation cellular phone or a wireless LAN (Local Area Network). The IMS enables not only to provide service in an IP base, but also to connect with a PSTN (Public Switched Telephone Network) to provide service.

Nevertheless, in terminal devices disclosed in WO02/09448, WO03/84096 and WO2004/073279, compatibility with the IMS is not taken into consideration at all. Since the IMS is a subsystem constructed on the PS domain, it is independent of the CS domain. For this reason, in order to include a 3G CS terminal in the IMS network, and to provide the 3G terminal with IMS service without affecting existing systems, it is necessary to convert a bearer protocol currently used in the CS domain into a bearer protocol currently used by the IMS.

Then, according to the standard specified by 3GPP at present, as an interworking system of a bearer protocol, a system having a form of:

IuCS [symbol] Nb [symbol] Mb [symbol] PSTN

as shown in FIG. 1 is adopted. FIG. 1 shows construction in related art for including a CS terminal in the IMS network. That is, CS terminal 1 which is a third generation cellular phone is connected to RNC (radio network controller) 2 of Node-B. RNC 2 communicates with CS-MGW (CS-media gateway) 3 through IuCS interface which is an interface at an Iu (interconnection point) between the RNC and the core network. CS-MGW 3 communicates with another CS-MGW 4 through an Nb interface. Both CS-MGW 3 and CS-MGW 4 are arranged within a 3G core network. CS-MGW 4 communicates with IM-MGW 6, which is a media gateway for the IMS and disposed in IMS network 5, through an Mb interface. IM-MGW 6 is connected to PSTN 7.

In this way, in the related art, interworking of the bearer protocol is achieved through a plurality of media gateways (CS-MGW 3, CS-MGW 4 and IM-MGW 6) and three interfaces (IuCS, Nb and Mb). However, there are tasks that overhead in each media gateway and each interface is large in this arrangement.

### SUMMARY OF THE INVENTION

The object of the present invention is to provide an interworking device which makes it possible to directly include a 3G CS terminal in an IMS network and can achieve bearer protocol conversion, without affecting existing systems.

According to a first aspect of the present invention, an interworking device performs interworking of the IuUP protocol in a CS domain and a protocol of an IMS which is a subsystem of a PS domain.

According to a second aspect of the present invention, an interworking device has: an IuCS interface unit for an IuUP protocol signal;

an Mb interface unit for an RFC3267 protocol signal; and protocol conversion means for performing protocol conversion between the IuUP protocol signal and the RFC3267 protocol signal, the protocol conversion means being connected to the IuCS interface unit and the Mb interface unit.

According to the present invention, it is possible to provide an interworking device which can directly include a 3G CS terminal in the IMS network and can achieve bearer protocol conversion, without affecting existing systems. That is, according to the interworking device according to the exemplary embodiment of the present invention, since it is possible to make the CS domain compatible to the IP, and to directly include a CS terminal into the IMS network, without affecting existing systems, the CS terminal is possible to use services which the IMS provides.

The above and other objects, features, and advantages of the present invention will become apparent from the following description based on the accompanying drawings which illustrate examples of preferred embodiments of the present invention.

### BRIEF DESCRIPTION OF THE DRAWINGS

FIG. 1 is a block diagram showing construction in related art for including a CS terminal in an IMS network;

FIG. 2 is a block diagram showing construction by which a CS terminal is included in the IMS network, and to which an interworking device according to an exemplary embodiment of the present invention is applied;

FIG. 3 is a block diagram illustrating the interworking device from an aspect of protocol conversion;

FIG. 4 is a sequence chart illustrating an outline of mapping in the interworking device; and

FIG. 5 is a block diagram showing construction of the interworking device.

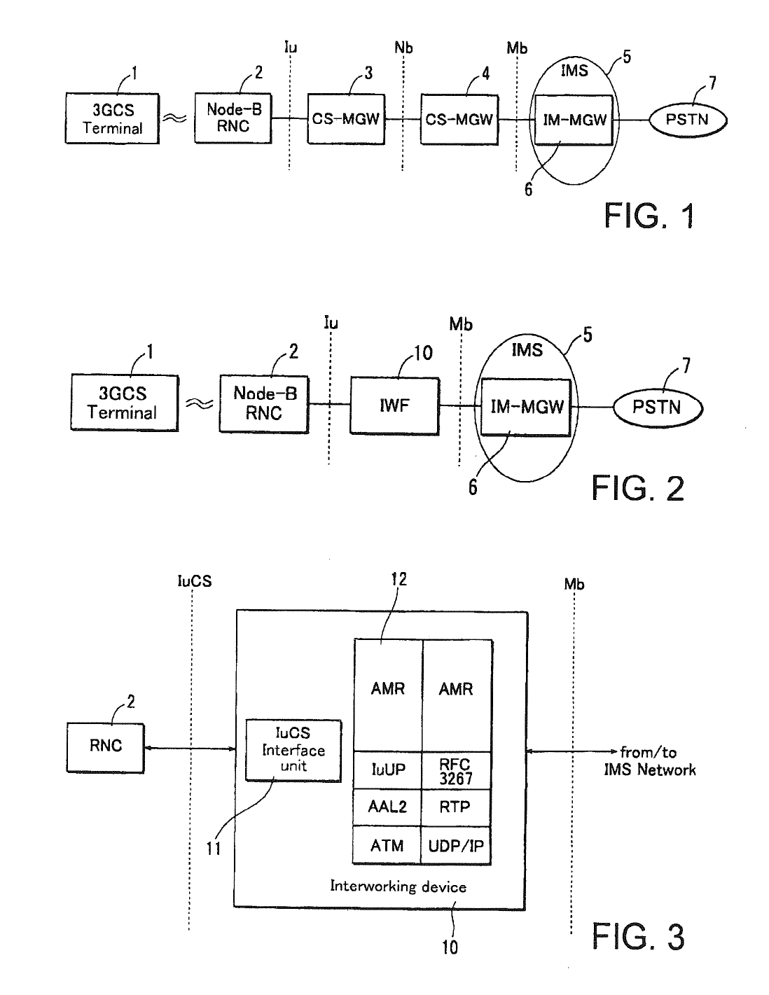

### DETAILED DESCRIPTION OF THE EXEMPLARY EMBODIMENT

FIG. 2 is an explanatory diagram about an interworking device based on an exemplary embodiment, and shows construction for including a CS terminal in an IMS network using this interworking device (IWF).

In order to directly include CS terminal 1 into IMS network 5, the interworking device of the exemplary embodiment performs direct interworking of an IuCS interface with an Mb interface as shown in FIG. 2. That is, 3G CS terminal 1 is connected to RNC (radio network controller) 2 of Node-B. RNC 2 communicates with interworking device 10 through an Iu interface, and interworking device 10 communicates with IM-MGW 6 in IMS network 5 through the Mb interface. IM-MGW 6 is connected to PSTN 7.

FIG. 3 illustrates an example of protocol conversion in interworking device 10 shown in FIG. 2. Interworking device 10 is characterized by performing bearer protocol conversion. Thereby, interworking device 10 of the exemplary embodiment serves as an SIP (Session Initiation Protocol) terminal when viewed from IMS network 5.

In addition, as shown in FIG. 3, interworking device 10 is characterized that it performs mapping an IuUP protocol, specified in 3GPP TS 25.415 used in the IuCS interface, into an RFC3267 protocol used in the Mb interface, and on the contrary, also mapping the RFC3267 protocol into the IuUP protocol The RFC3267 protocol is a Real-time Transport Protocol (RTP) in which a payload format and file format thereof is specified by RFC (Request for Comments) 3267 or RFC 4867 which are the Internet technical documents published by the Internet Society. Specifically, in order to perform mapping of Initialization information and Rate Control information between both protocols, interworking device 10 performs mapping shown in the following (A), (B) and (C)

(A) RFCI [symbol] FT mapping

(B) FQC [symbol] bit mapping

(C) CMR Header mapping

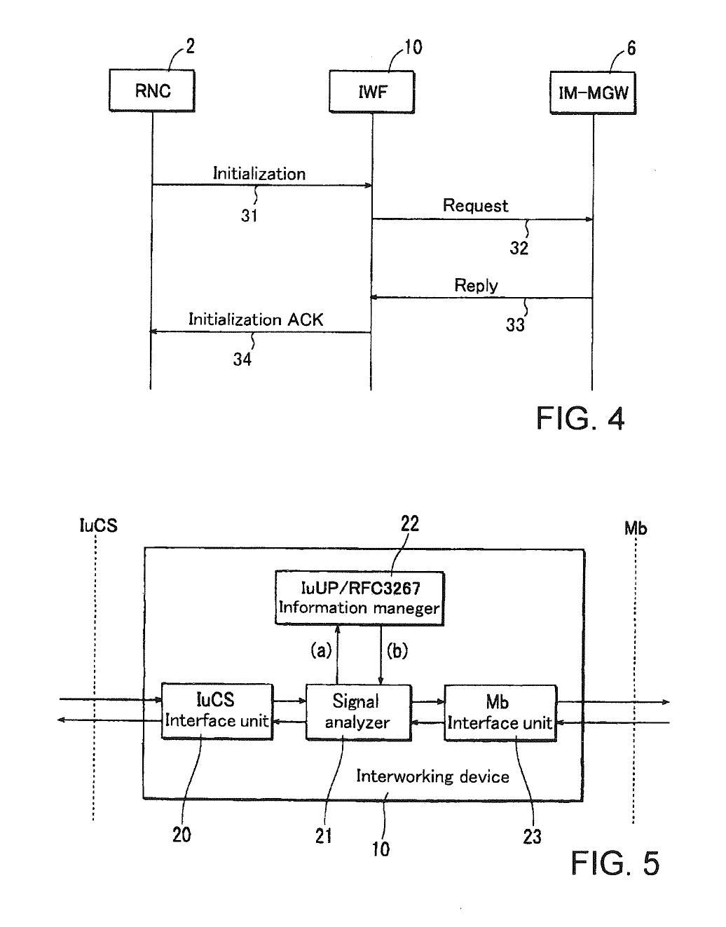

These outlines will be illustrated with reference to FIG. 4. FIG. 4 illustrates an outline of mapping in interworking device 10.

In FIG. 4, interworking device 10 receives Initialization signal 31 from RNC 2. In order to notify an RFCI (Radio Access Bearer (RAB) sub-Flow Combination Indicator) value included in Initialization signal 31 to IM-MGW 6, interworking device 10 maps it in an FT (Frame Type index) of an RFC3267 protocol, and transmits request signal 32.

Interworking device 10 transmits Initialization reply signal 34 to RNC 2 after receiving reply signal 33 to request signal 32.

Thereby, interworking device 10 can execute an Initialization procedure.

As shown in FIG. 3, interworking device 10 receives data 12, transmitted from RNC 2, in IuCS interface 11. Interworking device 10 holds the RFCI value, which is a parameter in the IuUP protocol of received data 12, as session information. When transmitting received data 12 toward the Mb interface after received data 12 is converted into data of the RTP, interworking device 10 maps the held RFCI value into the FT in the RFC3267 protocol to transmit it.

The mapping of the FQC (Frame Quality Classifier) in the IuUP protocol into the Q bit (i.e., a Frame quality indicator bit) in the RFC2367 protocol and the mapping of the Rate Control into the CMR (Codec Mode Request) are carried out in the similar way.

In this way, interworking device 10 can directly include a 3GPP CS terminal into the IMS and can provide IMS services, by mapping the IuUP protocol, used in the IuCS interface, into the RFC3267 protocol used in the Mb interface, and on the contrary, also by mapping the RFC3267 protocol into the IuUP protocol.

The correspondence relation of data elements for each layer between data transmitted to or received from RNC 2 and data transmitted to or received from the IMS network is illustrated in FIG. 3. Data elements of ATM (Asynchronous Transfer Mode), AAL2 (ATM Adaption layer type 2) and IuCP in data 12 on the RNC side correspond to data elements of UDP/IP (User Datagram Protocol/Internet Protocol), RTP and RFC3267 in data 13 on the IMS network side, respectively. Each of data 12, 13 includes AMR (Adaptive Multi Rate) data.

Interworking device 10 of this exemplary embodiment will be described in more detail. FIG. 5 illustrates detailed construction of interworking device 10.

Interworking device 10 includes signal analyzer 21 which analyzes signals in the IuUP protocol and signals in the RFC3267 protocol, IuUP/RFC3267 information manager 22 which manages the analysis result by the signal analyzer 21, IuCS interface unit 20 serving as an interface with RNC 2, and Mb interface unit 23 serving as an interface with IMS 5.

Interworking between the IuUP protocol and RFC3267 protocol will be described with referring to FIG. 5.

Interworking device 10 receives a signal, in which an IuUP header is included, by IuCS interface unit 20. Signal analyzer 21 analyzes the received signal, and extracts an RFCI value and an FQC value. Signal analyzer 21 then transmits the RFCI value and FQC value to IuUP/RFC3267 information manager 22 as indicated by arrow (a) in FIG. 5. Then, IuUP/RFC3267 information manager 22 determines the corresponding FT and CMR from the RFCI value, and corresponding Q bit from the FQC value, and transmits them to signal analyzer 21 as indicated by arrow (b) in FIG. 5. Signal analyzer 21 sets the received FT, Q bit, and CMR in an RFC3267 header, and transmits the signal to the IMS network through Mb interface unit 23.

On the contrary, an operation at the time when Mb interface unit 23 receives a signal in which the RFC3267 header is included is as follows.

Signal analyzer 21 analyzes the signal received by Mb interface unit 23, and extracts the FT, Q bit, and CMR values. Signal analyzer 21 then transmits the FT, Q bit, and CMR values to IuUP/RFC3267 information manager 22 as indicated by arrow (a) in FIG. 5. Then, IuUP/RFC3267 information manager 22 determines the corresponding RFCI value from the FT and CMR values, and corresponding FQC value from the Q bit, and transmits them to signal analyzer 21 as indicated by arrow (b) in FIG. 5 Signal analyzer 21 sets the received RFCI and FQC values in the IuUP header, and transmits the signal to the RNC through IuCS interface unit 20.

According to the above, interworking device 10 performs mapping shown in the following (D), (E) and (F).

(D) RFCI [symbol] FT mapping

(E) FQC [symbol] Q bit mapping

(F) CMR Header addition

In addition, since a Rate Control signal also exists in the IuUP protocol, it is necessary to map it into RFC3267 protocol, and to transmit the signal of RFC3267 protocol to IM-MGW 6 in IMS network 5. Interworking device 10 receives the Rate Control signal from IuCS interface unit 20. Signal analyzer 21 analyzes the received signal, and extracts an RFCI value which is requested to change. Signal analyzer 21 transmits the RFCI value to IuUP/RFC3267 information manager 22 as indicated by arrow (a). Then, IuUP/RFC3267 information manager 22 determines the corresponding CMR from the RFCI value, and transmits it to signal analyzer 21 as indicated by arrow (b). Signal analyzer 21 then sets the received CMR in the RFC3267 header, and transmits the Rate Control signal from Mb interface unit 23.

Furthermore, interworking device 10 receives a response to the Rate Control signal sent out from Mb interface unit 23 by Mb interface unit 23. Signal analyzer 21 analyzes the received signal to extract the CMR, and transmits the value of the CMR to IuUP/RFC3267 information manager 22 as indicated by arrow (a). IuUP/RFC3267 information manager 22 compares the CMR value with the RFCI value requested by the Rate Control signal received by IuCS interface unit 20. In consequence, when the request is acceptable, IuUP/RFC3267 information manager 22 transmits an ACK (acknowledgement) signal through IuCS interface unit 20, and when being not acceptable, IuUP/RFC3267 information manager 22 transmits a NACK (negative acknowledgement) signal through IuCS interface unit 20. Thereby, Rate Control processing is completed.

While an exemplary embodiment of the present invention has been described using specific terms, such description is for illustrative purposes only, and it is to be understood that changes and variations may be made without departing from the spirit or scope of the following claims.

What is claimed is:

1. An interworking device, comprising:
an IuCS interface unit for an IuUP protocol signal;
an Mb interface unit for an RFC3267 protocol signal; and
protocol conversion means for performing protocol conversion between the IuUP protocol signal and the RFC3267 protocol signal, the protocol conversion means being connected to the IuCS interface unit and the Mb interface unit.

2. The device according to claim 1, wherein the IuCS interface unit receives the IuUP protocol signal, the Mb interface unit transmits the RFC3267 protocol signal, and the protocol conversion means converts the IuUP protocol signal into the RFC3267 protocol signal.

3. The device according to claim 2, wherein the protocol conversion means comprises:
a signal analyzer which extracts an RFCI value and an FQC value from the IuUP protocol signal and sets an FT value, a Q bit and a CMR value in a header of the RFC3267 protocol signal; and
an information manager which determines the FT value, Q bit and CMR value based on the RFCI value and FQC value.

4. The device according to claim 1, wherein the Mb interface unit receives the RFC3267 protocol signal, the IuCS interface unit transmits the IuUP protocol signal, and the protocol conversion means converts the RFC3267 protocol signal into the IuUP protocol signal.

5. The device according to claim 4, wherein the protocol conversion means comprises:
a signal analyzer which extracts an FT value, a Q bit and a CMR value from the RFC3267 protocol signal and sets an RFCI value and an FOC value in a header of the IuUP protocol signal; and
an information manager which determines the RFCI value and FQC value based on the FT value, Q bit and CMR value.

6. The device according to claim 1, wherein the IuCS interface unit receives and transmits the IuUP protocol signal, the Mb interface unit receives and transmits the RFC3267 protocol signal, and the protocol conversion means converts the IuUP protocol signal into the RFC3267 protocol signal and converts the RFC3267 protocol signal into the IuUP protocol signal.

7. The device according to claim 6, wherein the protocol conversion means performs mapping of IuUP protocol into RFC3267 protocol, and mapping of the RFC3267 protocol into the IuUP protocol.

8. The device according to claim 6, wherein the protocol conversion means comprises:
a signal analyzer which extracts an RFCI value and an FQC value from a received IuUP protocol signal, extracts an FT value, a Q bit and a CMR value from a received RFC3267 protocol signal, sets the FT value, Q bit and CMR value in a header of a transmitting RFC3267 protocol signal, and sets the RFCI value and FQC value in a header of a transmitting IuUP protocol signal; and
an information manager which determines the FT value, Q bit and CMR value based on the RFCI value and FQC value, and determines the RFCI value and FQC value based on the FT value, Q bit and CMR value.

9. An interworking device, performing interworking of an IuUP protocol in a CS domain and a protocol of an IMS which is a subsystem of a PS domain.

10. A method of including a 3G CS terminal in an IMS network, comprising performing bearer protocol conversion of a signal of an RNC, which is connected to the CS terminal, and a signal of an IM-MGW using the interworking device according to claim 1.

11. A method of including a 3G CS terminal in an IMS network, comprising performing bearer protocol conversion of a signal of an RNC, which is connected to the CS terminal, and a signal of an IM-MGW using the interworking device according to claim 9.
